(19) United States
(12) Patent Application Publication
(10) Pub. No.: US 2019/0256218 A1
(43) Pub. Date: Aug. 22, 2019

(54) TRANSMISSION SYSTEM FOR AIRCRAFT STRUCTURE

(71) Applicant: Juan Manuel CORREA HAMILL, Mississauga (CA)

(72) Inventor: Juan Manuel CORREA HAMILL, Mississauga (CA)

(21) Appl. No.: 15/898,564

(22) Filed: Feb. 17, 2018

(51) Int. Cl. B64D 35/04; B64C 27/12

(52) U.S. Cl. CPC B64D 35/04; B64D 2027/005; B64C 27/12

(57) ABSTRACT

An apparatus includes a transmission system for an aircraft structure, in which the aircraft structure includes a first propeller assembly and a second propeller assembly, and an engine assembly. The transmission system is configured to (A) be coupled to the engine assembly, (B) be coupled to the first propeller assembly and the second propeller assembly. The transmission system is also configured to urge, in use, the first propeller assembly and the second propeller assembly to (i) operatively rotate in opposite directions relative to each other, and (ii) operatively rotate at different rotational speeds relative to the rotational speed of the engine assembly. The different rotational speeds of the first propeller assembly and the second propeller assembly, in use, urge the aircraft structure to move along a desired flight path.

### TECHNICAL FIELD

This document relates to the technical field of (and is not limited to) an apparatus including an aircraft structure having a transmission system, and/or an apparatus including a transmission system for (installation in) an aircraft structure (and method therefor).

### BACKGROUND

An aircraft engine is configured to generate mechanical power for rotating the propeller of an aircraft. An aircraft transmission system (hereinafter referred to as the transmission system) is configured to connect (couple) an aircraft engine to a propeller of an aircraft (also known as an aircraft structure).

### SUMMARY

It will be appreciated that there exists a need to mitigate (at least in part) at least one problem associated with the existing transmission systems for aircraft structures (also called the existing technology). After much study of the known systems and methods with experimentation, an understanding (at least in part) of the problem and its solution has been identified (at least in part) and is articulated (at least in part) as follows:

Known multirotor (multi-propeller) aircrafts include engines allocated at (positioned at) the periphery (outer edge or envelope) of the aircrafts, in which each engine is utilized for individually powering (driving or rotating) at least one propeller (or a pair of propellers), etc. At least one disadvantage of this arrangement is the additional weight (for the engines) to be carried by the aircrafts, which may (disadvantageously) reduce the effective range or reach of the aircrafts, or may increase fuel costs, etc.

What may be needed (for an aircraft structure) is, preferably, individual control or selective control of the propeller speeds (rotational speeds) of selected propellers via an application of mechanical power from at least one engine assembly (one or more engine assemblies, a single engine assembly, etc.) to the propellers. Of course, what also may be needed is utilizing at least two or more engines for driving (powering respective groupings of propellers, while reducing the total number of engines to be deployed on the aircrafts). In this manner, weight restrictions inherent to known multirotor (multi-propeller) aircrafts may advantageously result in power and/or energy consumption reduction, which may improve (at least in part) the payload loading capability and/or the flight duration capability of the aircraft.

What may be needed (for an aircraft structure) is, preferably, paring and rotating the propellers in opposite directions (relative to each other), and in this manner the paired propellers may nullify an undesired rotational effect resulting from the rotational inertia that is generated by each of the propellers of the aircraft.

What may be needed (for an aircraft structure) is, preferably, a transmission system for an aircraft structure in which the transmission system is configured to vary the amount of mechanical energy to be respectively individually delivered to each of the propellers (or a set of propellers) of the aircraft structure.

What may be needed (for an aircraft structure) is, preferably, a transmission system configured to (A) receive the mechanical energy from an engine assembly, and (B) distribute the mechanical energy (that was received from the engine assembly) to the propellers. This is done in such a way that the transmission system, in use, urges at least two (or more) of the propellers to rotate at rotational speeds (and rotational directions) that are different from each other.

What may be needed (for an aircraft structure) is, preferably, a single engine assembly utilized for providing mechanical power to a transmission system (for the aircraft structure).

To mitigate, at least in part, at least one problem associated with the existing technology, there is provided (in accordance with a major aspect) an apparatus. The apparatus includes and is not limited to an aircraft structure. A first propeller assembly and a second propeller assembly are configured to: (A) be supported by the aircraft structure at a first propeller position and a second propeller position, respectively, and (B) impart, in use, a thrust force to the aircraft structure (this is done in such a way that the aircraft structure is movable upwardly and away from the ground), and (C) be rotatable in opposite directions relative to each other, and (D) reduce (mitigate), at least in part, a horizontal rotational effect applied to the aircraft structure by the individual rotation of each of the first propeller assembly and the second propeller assembly. An engine assembly is configured to be supported by the aircraft structure. A transmission system is configured to: (A) be supported by the aircraft structure, and (B) be coupled (connected) to the engine assembly, and (C) be coupled (connected) to the first propeller assembly and the second propeller assembly (this is done in such a way that the transmission system, in use, urges the first propeller assembly and the second propeller assembly to be rotated once the engine assembly is activated), and (D) urge, in use, the first propeller assembly and the second propeller assembly to: (i) operatively rotate in opposite directions relative to each other, and (ii) operatively rotate at different rotational speeds relative to the rotational speed of the engine assembly. The result of the above arrangement is such that the different rotational speeds (the difference between the magnitudes of the rotational speeds) of the first propeller assembly and the second propeller assembly, in use, urge the aircraft structure to move (fly) along a desired path (flight path) relative to the ground.

To mitigate, at least in part, at least one problem associated with the existing technology, there is provided (in accordance with a second major aspect) an apparatus. The apparatus is for an aircraft structure. The aircraft structure includes a first propeller assembly and a second propeller assembly which are configured to: (A) be supported by the aircraft structure at a first propeller position and a second propeller position, respectively, and (B) impart, in use, a thrust force to the aircraft structure (this is done in such a way that the aircraft structure is movable upwardly and away from the ground), and (C) be rotatable in opposite directions relative to each other, and (D) reduce, at least in part, a horizontal rotational effect applied to the aircraft structure by the individual rotation of each of the first propeller assembly and the second propeller assembly, and an engine assembly that is configured to be supported by the aircraft structure. The apparatus includes (and is not limited to) a transmission system configured to be supported by the aircraft structure. The transmission system is also configured to be coupled (connected) to the engine assembly. The transmission system is also configured to be coupled (connected) to the first propeller assembly and the second propeller assembly. This is done in such a way that the transmission system, in use, urges the first propeller assembly and the second propeller assembly to be rotated once the engine assembly is activated. The transmission system is also configured to urge, in use, the first propeller assembly and the second propeller assembly to operatively rotate in opposite directions relative to each other. The transmission system is also configured to operatively rotate at different rotational speeds relative to the rotational speed of the engine assembly. The different rotational speeds of the first propeller assembly and the second propeller assembly, in use, urge the aircraft structure to fly along a desired flight path relative to the ground.

To mitigate, at least in part, at least one problem associated with the existing technology, there is provided (in accordance with a second major aspect) an apparatus. The includes: a transmission system configured to be supported by an aircraft structure, in which the aircraft structure includes: a first propeller assembly and a second propeller assembly which are configured to: (A) be supported by the aircraft structure at a first propeller position and a second propeller position, respectively, and (B) impart, in use, a thrust force to the aircraft structure in such a way that the aircraft structure is movable upwardly and away from the ground, and (C) be rotatable in opposite directions relative to each other, and (D) reduce, at least in part, a horizontal rotational effect applied to the aircraft structure by an individual rotation of each of the first propeller assembly and the second propeller assembly. In accordance with an option, there if further provided an engine assembly that is configured to be supported by the aircraft structure. In accordance with another option, the transmission system further configured to: be coupled to the engine assembly; and be coupled to the first propeller assembly and the second propeller assembly in such a way that the transmission system, in use, urges the first propeller assembly and the second propeller assembly to be rotated once the engine assembly is activated; and urge, in use, the first propeller assembly and the second propeller assembly to: operatively rotate in opposite directions relative to each other; and operatively rotate at different rotational speeds relative to a rotational speed of the engine assembly; and whereby the different rotational speeds of the first propeller assembly and the second propeller assembly, in use, urge the aircraft structure to fly along a desired flight path relative to the ground.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a top perspective view (at least in part) of an embodiment of an aircraft structure, and a top perspective view (at least in part) of an embodiment of a transmission system for the aircraft structure; and

FIG. 2 depicts a bottom perspective view (at least in part) of an embodiment of the aircraft structure, and a bottom perspective view (at least in part) of an embodiment of the transmission system for the aircraft structure of FIG. 1; and

FIG. 3, FIG. 4 and FIG. 5 depict top views of embodiments of the transmission system of FIG. 1; and

FIG. 6 depicts a perspective side view of an embodiment of the transmission system of FIG. 1; and

FIG. 7 depicts a schematic view of an embodiment of a transmission controller of the transmission system of FIG. 6; and

FIG. 8 depicts a schematic view of an embodiment of a flow chart of an embodiment of the transmission controller of the transmission system of FIG. 7; and

FIG. 9 depicts a partial cross-sectional perspective view of an embodiment of the transmission system of FIG. 6; and

FIG. 10 and FIG. 11 depict close-up perspective views of embodiments of the transmission system of FIG. 6.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 aircraft structure
104 first propeller assembly
106 second propeller assembly
107 engine assembly
108 engine output shaft
110 transmission system
111 engine output coupler
201 input shaft coupler
202 transmission input shaft assembly
204 first transmission input shaft
206 second transmission input shaft
208 contra-rotating mechanism
209 transmission shaft support assembly
214 first power conversion assembly
216 second power conversion assembly
223 transmission controller
224 first variable-velocity assembly
225 flight data
226 second variable-velocity assembly
234 first transmission output assembly
236 second transmission output assembly
301 first input conversion gear
303 first output conversion gear
311 second input conversion gear
313 second output conversion gear
501 first driving pulley
503 first input shaft
505 first coupling device
507 first driven pulley
509 first output shaft
511 first shaft coupler
521 second driving pulley
523 second input shaft
525 second coupling device
527 second driven pulley
529 second output shaft
531 second shaft coupler
601 first transmission-shaft support structure
603 first extension shaft
605 first variable angle shaft coupler
607 first shaft portion
609 first variable-length shaft assembly
700 flow chart
702 memory assembly
704 executable program
710 first operation
712 second operation
804 first propeller position
806 second propeller position

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

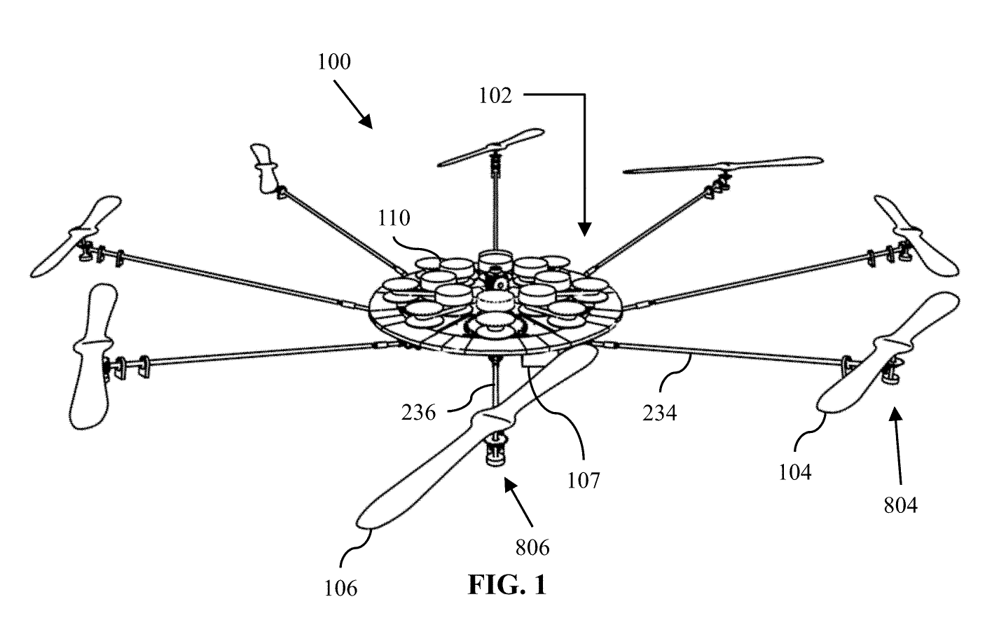

FIG. 1 depicts a top perspective view (at least in part) of an embodiment of an aircraft structure 102, and a top perspective view (at least in part) of an embodiment of a transmission system 110 for the aircraft structure 102.

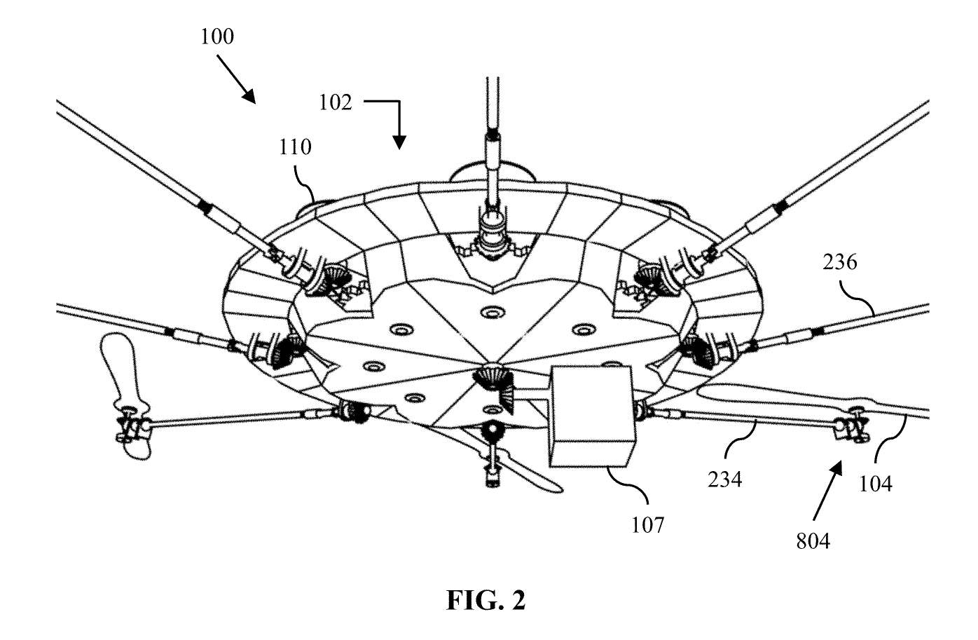

FIG. 2 depicts a bottom perspective view (at least in part) of an embodiment of the aircraft structure 102, and a bottom perspective view (at least in part) of an embodiment of the transmission system 110 for the aircraft structure 102 of FIG. 1.

Referring to a first major embodiment as depicted in FIG. 1 (and all other FIGS.), an apparatus 100 includes and is not limited to (comprises) a synergistic combination of an aircraft structure 102, a first propeller assembly 104, a second propeller assembly 106, an engine assembly 107, and a transmission system 110.

Embodiments of the aircraft structure 102 are depicted in FIG. 1 and FIG. 2, and any equivalents thereof. The aircraft structure 102 is any machine configured to (A) fly, (B) travel or move through the air, (C) counter the force of gravity (such as by using static lift, dynamic lift of an airfoil, the downward thrust from an engine, etc.), (D) touch (at least in part) a working surface (such as, water, ice, air, the ground, a flat horizontal surface, etc., and any equivalent thereof) for the case where the aircraft structure 102 is traveling (moving) through the air, (E) support at least two or more propellers, and/or (F) be supported, at least in part, for flight in the air (such as by buoyancy or by the dynamic action of air on the surfaces of the aircraft, such as for powered airplanes, gliders, and helicopters, etc.). Embodiments of the aircraft structure 102 may include (and are not limited to) airplanes, helicopters, airships (including blimps), gliders, and hot air balloons, unmanned aerial vehicles (configured to be remotely controlled or self-controlled by an onboard computer, etc., and any equivalent thereof), powered propeller vehicles (such as cars, etc., configured to be moved along the ground), airboats (configured to be moved along the water), etc., and any equivalents thereof. Preferably, the aircraft structure 102 (an embodiment of which is depicted in FIG. 1) includes a multi-propeller helicopter, a multi-propeller drone (also called an autonomous aircraft), a multi-propeller aircraft, and any equivalents thereof. The aircraft structure 102 may include an aircraft chassis (known and not necessarily depicted).

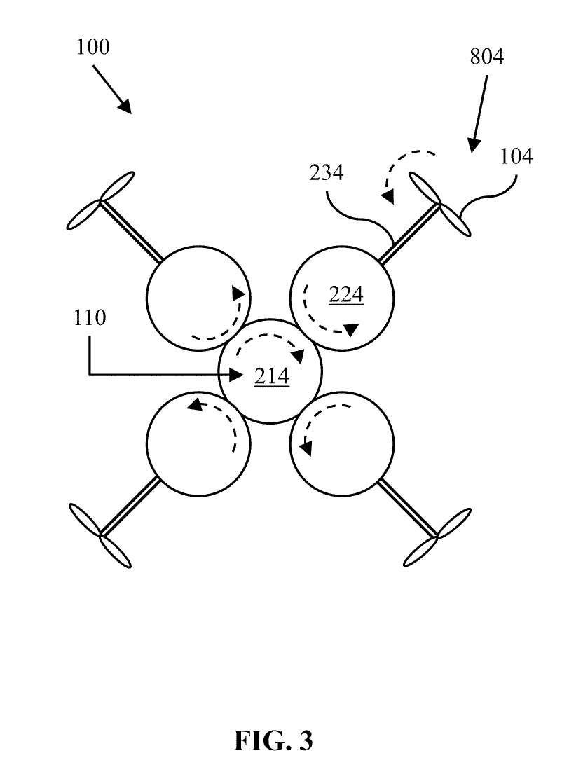

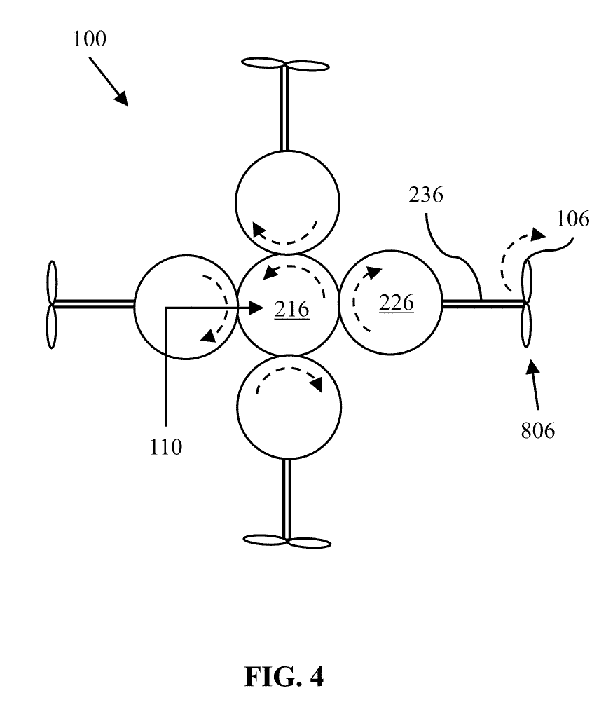

The first propeller assembly 104 and the second propeller assembly 106 (embodiments of which are depicted in FIG. 1, FIG. 2, FIG. 3, FIG. 4, and FIG. 5, and any equivalents thereof, and any equivalents thereof), are (each) configured to be supported by the aircraft structure 102 at a first propeller position 804 and a second propeller position 806, respectively. The first propeller assembly 104 and the second propeller assembly 106 are also (each) configured to impart, in use, a thrust force to the aircraft structure 102. This is done in such a way that the aircraft structure 102 is movable upwardly and away from the ground. The first propeller assembly 104 and the second propeller assembly 106 are also (each) configured to be rotatable in opposite directions relative to each other. The first propeller assembly 104 and the second propeller assembly 106 are also (each) configured to reduce (mitigate), at least in part, a horizontal rotational effect applied to the aircraft structure 102 (preferably, by the individual rotation of each of the first propeller assembly 104 and the second propeller assembly 106). Preferably, the first propeller assembly 104 is positioned (stationed) at a first propeller position 804. The second propeller assembly 106 is positioned (stationed) at a second propeller position 806.

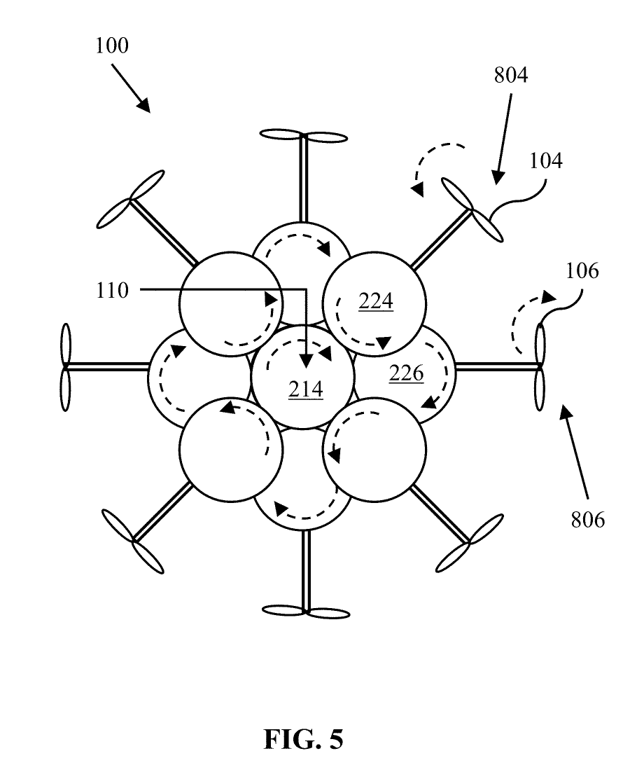

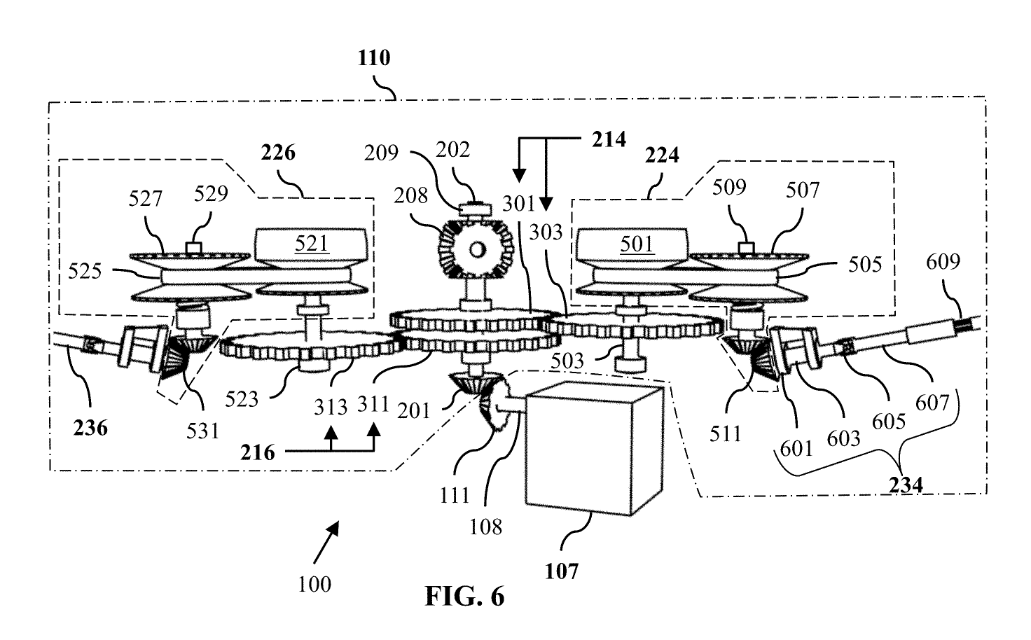

The engine assembly 107 (embodiments of which are depicted in FIG. 1 and FIG. 6, and any equivalents thereof) may include an electrical motor, a gas-powered motor, and any equivalents thereof, and/or any suitable number thereof. The engine assembly 107 may include at least one engine assembly (one or more engine assemblies) so that operation of the transmission system 110 may be sustained temporarily in the event of failure of at least one of the engine assemblies (any one or more engine assemblies, such as a primary engine, etc.). The engine assembly 107 is configured to be supported by the aircraft structure 102.

The transmission system 110 may be called a power transmission system. The transmission system 110 (an embodiment of which is depicted in FIG. 6, and other embodiments are depicted in FIG. 3, FIG. 4 and FIG. 5, and any equivalents thereof) is configured to be supported by the aircraft structure 102. Preferably, the aircraft structure 102 is configured to support the components of the transmission system 110. Preferably, the aircraft structure 102 is configured to encase and hold in position the elements of the transmission system 110. The transmission system 110 is further configured to be coupled (connected) to the engine assembly 107. The transmission system 110 is further configured to be coupled (connected) to the first propeller assembly 104 and the second propeller assembly 106. This is done in such a way that the transmission system 110, in use, urges the first propeller assembly 104 and the second propeller assembly 106 to be rotated once the engine assembly 107 is activated. The transmission system 110 is further configured to urge, in use, the first propeller assembly 104 and the second propeller assembly 106 to operatively rotate in opposite directions relative to each other. The transmission system 110 is further configured to urge, in use, the first propeller assembly 104 and the second propeller assembly 106 to operatively rotate at different rotational speeds relative to the speed of the engine assembly 107.

In accordance with a preferred embodiment, the first propeller assembly 104 and the second propeller assembly 106, in use, contra-rotate relative to each other, and the elements of the transmission system 110, in use, counter-rotate relative to each other to negate rotational inertia effect on the aircraft structure 102.

The transmission system 110, in use, urges or causes (is configured to urge) the different rotational speeds (the difference between the magnitudes of the rotational speeds) of the first propeller assembly 104 and the second propeller assembly 106 so that the first propeller assembly 104 and the second propeller assembly 106, in use, urge the aircraft structure 102 to move (fly) along a desired path (flight path) relative to the ground.

Advantageously, by having the first propeller assembly 104 and the second propeller assembly 106 rotatable at different relative rotational speeds, the first propeller assembly 104 and the second propeller assembly 106, in use, urge movement of the aircraft structure 102 along a desired flight path depending on the tilt imposed on the aircraft structure 102 by the difference in rotational speeds between the first propeller assembly 104 and the second propeller assembly 106 (depending on the tilt imposed on the aircraft due to the relative rotational speeds between the first propeller assembly 104 and the second propeller assembly 106).

Referring to a second major embodiment as depicted in FIG. 1 (and all other FIGS.), an apparatus 100 is for an aircraft structure 102. The aircraft structure 102 includes (and is not limited to) a synergistic combination of (A) a first propeller assembly 104, (B) a second propeller assembly 106, and (C) an engine assembly 107. The first propeller assembly 104 and the second propeller assembly 106 are configured to be supported by the aircraft structure 102 at a first propeller position 804 and a second propeller position 806, respectively. The first propeller assembly 104 and the second propeller assembly 106 are also configured to impart, in use, a thrust force to the aircraft structure 102 (this is done in such a way that the aircraft structure 102 is movable upwardly and away from the ground). The first propeller assembly 104 and the second propeller assembly 106 are also configured to be rotatable in opposite directions relative to each other. The first propeller assembly 104 and the second propeller assembly 106 are also configured to reduce, at least in part, a horizontal rotational effect applied to the aircraft structure 102 by the individual rotation of each of the first propeller assembly 104 and the second propeller assembly 106. The engine assembly 107 is configured to be supported by the aircraft structure 102.

The apparatus 100 includes and is not limited to (comprises) a transmission system 110 configured to be supported by the aircraft structure 102. The transmission system 110 is further configured to be coupled (connected) to the engine assembly 107. The transmission system 110 is further configured to be coupled (connected) to the first propeller assembly 104 and the second propeller assembly 106. This is done in such a way that the transmission system 110, in use, urges the first propeller assembly 104 and the second propeller assembly 106 to be rotated once the engine assembly 107 is activated. The transmission system 110 is further configured to urge, in use, the first propeller assembly 104 and the second propeller assembly 106 to operatively rotate in opposite directions relative to each other. Embodiments of the transmission system 110 are further configured to operatively rotate at different rotational speeds relative to the rotational speed of the engine assembly 107. It will be appreciated that not only do the propeller assemblies (104, 106) contra-rotate, the elements of the transmission system 110 also counter-rotate as well, which may negate rotational inertia effect on the aircraft structure 102. A gyroscopic method may be utilized for stabilization of the aircraft structure 102 during flight. A gyroscopic effect of the components of the transmission system 110 on the aircraft structure 102 may improve (at least in part) the stabilization and the maneuverability of the aircraft structure 102.

The transmission system 110, in use, urges or causes (is configured to urge) the different rotational speeds (the difference between the magnitudes of the rotational speeds) of the first propeller assembly 104 and the second propeller assembly 106 so that the first propeller assembly 104 and the second propeller assembly 106, in use, urge the aircraft structure 102 to move (fly) along a desired path (flight path) relative to the ground.

FIG. 3, FIG. 4 and FIG. 5 depict top views of embodiments of the transmission system 110 of FIG. 1.

Referring to the embodiments as depicted in FIG. 3, FIG. 4, and FIG. 5, the transmission system 110 is configured to receive the mechanical power from the engine assembly 107 (depicted in FIG. 1 or FIG. 2), and transmit (convey) the mechanical power from the engine assembly 107 to at least two propellers (such as, the first propeller assembly 104 and the second propeller assembly 106).

Referring to the embodiment as depicted in FIG. 3 and FIG. 5, the transmission system 110 includes (and is not limited to) a first power conversion assembly 214 configured to be coupled (either directly or indirectly) to an output of the engine assembly 107. This is done in such a way that the engine assembly 107, in use, rotates the first power conversion assembly 214. For instance, FIG. 6 depicts an embodiment of the manner in which the first power conversion assembly 214 is coupled to the output of the engine assembly 107.

The transmission system 110 further includes (and is not limited to) a first variable-velocity assembly 224 configured to be coupled (either directly or indirectly) to an output of the first power conversion assembly 214. This is done in such a way that the first power conversion assembly 214, in use, rotates the first variable-velocity assembly 224. For instance, FIG. 6 depicts an embodiment of the manner in which the first variable-velocity assembly 224 is coupled to the output of the first power conversion assembly 214.

The transmission system 110 further includes (and is not limited to) a first transmission output assembly 234 configured to (A) couple to an output of the first variable-velocity assembly 224, and (B) couple to the first propeller assembly 104. This is done in such a way that the first variable-velocity assembly 224, in use, rotates the first transmission output assembly 234, and the first transmission output assembly 234, in use, rotates the first propeller assembly 104. For instance FIG. 6 depicts an embodiment of the manner in which the first transmission output assembly 234 is coupled to the output of the first variable-velocity assembly 224 and is coupled to the first propeller assembly 104. Preferably, the first transmission output assembly 234 and the second transmission output assembly 236 are configured be adjustable (lengthwise-adjustable and angle-adjustable) to allow for flexibility of the aircraft structure 102.

The transmission system 110 further includes (and is not limited to) a second power conversion assembly 216 configured to be coupled (either directly or indirectly) to an output of the engine assembly 107. This is done in such a way that the engine assembly 107, in use, rotates the second power conversion assembly 216. For instance, FIG. 6 depicts an embodiment of the manner in which the second power conversion assembly 216 is coupled to the output of the engine assembly 107.

Referring to the embodiment as depicted in FIG. 4 and FIG. 5, the transmission system 110 further includes (and is not limited to) a second variable-velocity assembly 226 configured to be coupled (either directly or indirectly) to an output of the second power conversion assembly 216. This is done in such a way that the second power conversion assembly 216, in use, rotates the second variable-velocity assembly 226. For instance, FIG. 6 depicts an embodiment of the manner in which the second variable-velocity assembly 226 is coupled to the output of the second power conversion assembly 216.

The transmission system 110 further includes (and is not limited to) a second transmission output assembly 236 configured to (A) couple to an output of the second variable-velocity assembly 226, and (B) couple to the second propeller assembly 106. This is done in such a way that the second variable-velocity assembly 226, in use, rotates that the second transmission output assembly 236, and the second transmission output assembly 236, in use, rotates the second propeller assembly 106. For instance, FIG. 6 depicts an embodiment of the manner in which the second transmission output assembly 236 is coupled to the output of the second variable-velocity assembly 226 and is coupled to the second propeller assembly 106.

Referring to the embodiment as depicted in FIG. 5, the transmission system 110 is configured to counter rotate the first propeller assembly 104 and the second propeller assembly 106. Advantageously, by having the first propeller assembly 104 and the second propeller assembly 106 rotatable at different relative rotational speeds, the first propeller assembly 104 and the second propeller assembly 106, in use, urge movement of the aircraft structure 102 along a desired flight path (depending on the relative rotational speeds between the first propeller assembly 104 and the second propeller assembly 106, or depending on the tilt imposed on the aircraft due to the relative rotational speeds between the first propeller assembly 104 and the second propeller assembly 106).

FIG. 6 depicts a perspective side view of an embodiment of the transmission system 110 of FIG. 1.

Referring to the embodiment as depicted in FIG. 6, the engine assembly 107 includes an engine output shaft 108 and an engine output coupler 111 (such as a beveled gear portion and any equivalent thereof). The engine output shaft 108 is configured to be rotatable. The engine output coupler 111 is affixed to a portion (the end portion) of the engine output shaft 108. The engine output coupler 111 is configured to be rotatable.

Preferably, the transmission system 110 further includes (and is not limited to) an input shaft coupler 201 (such as a beveled gear portion and any equivalent thereof), a transmission input shaft assembly 202, a contra-rotating mechanism 208 (such as a contra-rotating gearbox assembly and any equivalent thereof), a transmission shaft support assembly 209, a first power conversion assembly 214, a second power conversion assembly 216, a first variable-velocity assembly 224, a second variable-velocity assembly 226, a first transmission output assembly 234, and a second transmission output assembly 236.

The first power conversion assembly 214 is configured to feed mechanical power to the first variable-velocity assembly 224, which then feeds mechanical power to the first propeller assembly 104.

The second power conversion assembly 216 is configured to feed mechanical power to the second variable-velocity assembly 226, which then feeds mechanical power to the second propeller assembly 106.

The input shaft coupler 201 is configured to be coupled to the engine output coupler 111. This is done in such a way that the input shaft coupler 201 is rotatable once the engine output coupler 111 is made to rotate (by activation of the engine assembly 107). The input shaft coupler 201 may include a shaft gear. The input shaft coupler 201 may include a 90-degree shaft gear.

The transmission input shaft assembly 202 is affixed to the input shaft coupler 201. This is done in such a way that the transmission input shaft assembly 202 is made to rotate once the input shaft coupler 201 is made to rotate.

The contra-rotating mechanism 208 is coupled to (mounted to) a portion of the transmission input shaft assembly 202, and is spaced apart from the input shaft coupler 201. The contra-rotating mechanism 208 is supported by the transmission input shaft assembly 202 and in turn by the transmission shaft support assembly 209 (such as bearing devices, etc.).

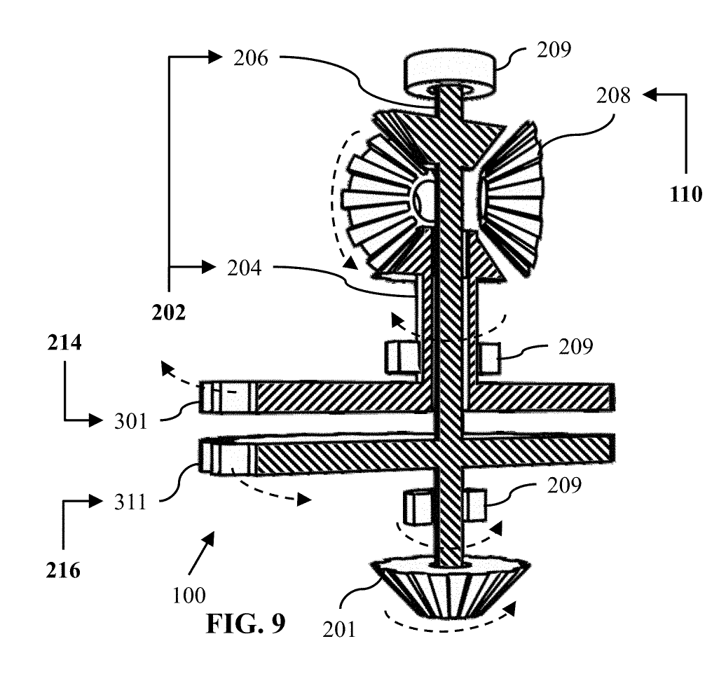

Details regarding the specific embodiment and aspects of the contra-rotating mechanism 208 are depicted in FIG. 9 (and are described in connection with the description for FIG. 9).

The transmission shaft support assembly 209 is configured to support the rotation of the transmission input shaft assembly 202. The transmission shaft support assembly 209 is configured to support simultaneous rotation of the first transmission input shaft 204 and the second transmission input shaft 206 relative to each other.

The first power conversion assembly 214 is configured to be coupled to (for utilization of, or for rotating) the first transmission output assembly 234 (which in turn is coupled to the first propeller assembly 104 as depicted in FIG. 5).

The second power conversion assembly 216 is configured to be coupled to (for utilization of, or for rotating) the second transmission output assembly 236 (which in turn is coupled to the second propeller assembly 106 as depicted in FIG. 5).

The first variable-velocity assembly 224 is configured to be coupled to the first propeller assembly 104. The second variable-velocity assembly 226 is configured to be coupled to the second propeller assembly 106. It will be appreciated that the components of the first variable-velocity assembly 224 may be similar to the components of the second variable-velocity assembly 226.

The first variable-velocity assembly 224 includes a first input shaft 503 and a first output shaft 509. The second variable-velocity assembly 226 includes a second input shaft 523 and a second output shaft 529. The first variable-velocity assembly 224 and the second variable-velocity assembly 226 may each include a continuously variable transmission (CVT). The continuously variable transmission (also known as a single-speed transmission, stepless transmission, pulley transmission, or, in case of motorcycles, a twist-and-go) is an automatic transmission that may change seamlessly through a continuous range of effective gear ratios. The flexibility of a CVT allows the input shafts (the first input shaft 503 and the second input shaft 523) to maintain a constant angular velocity while the output shafts (the first output shaft 509 and the second output shaft 529) may be varied (may have variable rotational speeds, relative to the input shaft 108 of the engine assembly 107).

The first transmission output assembly 234 is configured to be coupled to the first propeller assembly 104. The second transmission output assembly 236 is configured to be coupled to the second propeller assembly 106. The first transmission output assembly 234 and the second transmission output assembly 236 are configured to be rotatable in opposite directions relative to each other. It will be appreciated that components of the first transmission output assembly 234 may be the same as the components of the second transmission output assembly 236.

Referring to the embodiments as depicted in FIG. 6 and in FIG. 9, the first power conversion assembly 214 may include a first input conversion gear 301 and a first output conversion gear 303. The first input conversion gear 301 is coupled to the first transmission input shaft 204 of the transmission input shaft assembly 202 (which is affixed to an input portion of the contra-rotating mechanism 208, as depicted in the embodiment of FIG. 9). The first output conversion gear 303 is coupled to the first variable-velocity assembly 224.

Referring to the embodiment as depicted in FIG. 9, the transmission input shaft assembly 202 includes the first transmission input shaft 204 and the second transmission input shaft 206. The first transmission input shaft 204 is affixed to the output portion of the contra-rotating mechanism 208, and the second transmission input shaft 206 is affixed to the input portion of the contra-rotating mechanism 208.

Referring to the embodiments as depicted in FIG. 6 and in FIG. 9, the second power conversion assembly 216 includes a second input conversion gear 311, and a second output conversion gear 313. The second input conversion gear 311 is coupled to the second transmission input shaft 206 of the transmission input shaft assembly 202 (which is affixed to an output portion of the contra-rotating mechanism 208, as depicted in the embodiment of FIG. 9). The second output conversion gear 313 is coupled to the second variable-velocity assembly 226.

Referring to the embodiment as depicted in FIG. 6, the first variable-velocity assembly 224 (for the first propeller assembly 104) is operated independently from the second variable-velocity assembly 226 (for the second propeller assembly 106). The first variable-velocity assembly 224 and the second variable-velocity assembly 226 are each configured to provide (convey or transmit) a different amount of mechanical energy to the first propeller assembly 104 and the second propeller assembly 106.

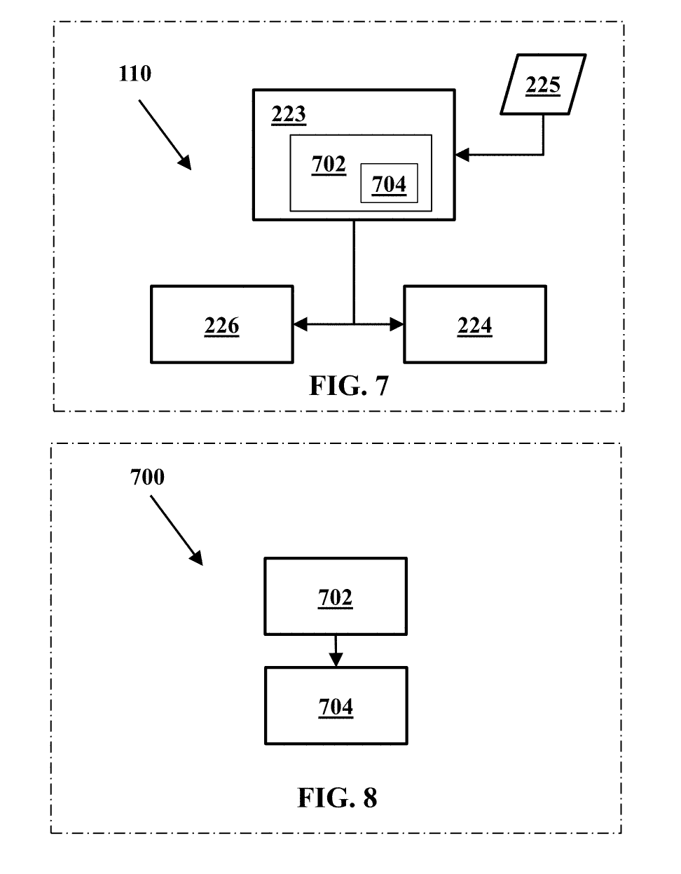

Referring to the embodiment as depicted in FIG. 6, the first variable-velocity assembly 224 includes (and is not limited to) a first driving pulley 501, a first input shaft 503, a first coupling device 505, a first driven pulley 507, a first output shaft 509, and a first shaft coupler 511. The embodiment as depicted in FIG. 7 and FIG. 8 are utilized for the control of the first variable-velocity assembly 224 and the second variable-velocity assembly 226. Moreover, the first power conversion assembly 214 and the second power conversion assembly 216 are configured to power (drive or transfer power to) the first variable-velocity assembly 224 (which is coupled to the first propeller assembly 104) and the second variable-velocity assembly 226 (which is coupled to the second propeller assembly 106)). Known devices may be utilized for interfacing the transmission controller 223 (as depicted in FIG. 7) to the first power conversion assembly 214 and the second power conversion assembly 216 (and therefore are not described here in any specific details). The first driving pulley 501 is coupled to the first input shaft 503 (this is done in such a way that the first driving pulley 501 is made to be rotated once the first input shaft 503 is rotated). An output of the first power conversion assembly 214 (such as the first output conversion gear 303 of the first power conversion assembly 214) is configured to rotate the first input shaft 503. The first coupling device 505 may include a belt, steel belt, or other form of coupling and any equivalent thereof. The first coupling device 505 is configured to rotate the first driven pulley 507. The first coupling device 505 is configured to rotate the first driven pulley 507 in response to rotation of the first driving pulley 501. The first driven pulley 507 is configured to rotate the first output shaft 509 (once the first coupling device 505, in use, rotates the first driven pulley 507). The first output shaft 509 is connected to the first shaft coupler 511 (in such a way that the first output shaft 509 and the first shaft coupler 511 rotate in unison). The first shaft coupler 511 is configured to be coupled to the first transmission output assembly 234 (the input of the first transmission output assembly 234). The first shaft coupler 511 may include a fixed-angle shaft coupling, or any form of shaft-coupling assembly (and any equivalent thereof).

The second variable-velocity assembly 226 (for the second propeller assembly 106) includes (and is not limited to) components that are similar to the components of the first variable-velocity assembly 224 (such as a second driving pulley 521, a second input shaft 523, a second coupling device 525, a second driven pulley 527, a second output shaft 529, and a second shaft coupler 531).

The first transmission output assembly 234 is for the first propeller assembly 104. The second transmission output assembly 236 is for the second propeller assembly 106. The first transmission output assembly 234 includes (and is not limited to) a first transmission-shaft support structure 601, a first extension shaft 603 (also called a shaft segment), a first variable angle shaft coupler 605, a first shaft portion 607, and a first variable-length shaft assembly 609. The first transmission-shaft support structure 601 is configured to support rotation of the first extension shaft 603. The first extension shaft 603 is configured to rotate once the first shaft coupler 511 is made to rotate. The first variable angle shaft coupler 605 is configured to couple the first extension shaft 603 to the first shaft portion 607. The first variable-length shaft assembly 609 is attached to the end portion of the first shaft portion 607. The first variable-length shaft assembly 609 is configured to be coupled to the first propeller assembly 104 (as depicted in FIG. 5) in such a way that the first propeller assembly 104 is made to rotate once the first variable-length shaft assembly 609 is made to rotate. It will be appreciated that the second transmission output assembly 236 (for the second propeller assembly 106) includes components that are similar to the components of the first transmission output assembly 234. It will be appreciated that the combination of the first variable-length shaft assembly 609 and the first variable angle shaft coupler 605 allow for flexibility of the aircraft structure 102, and powering of multiple propellers from a single power input (a single engine assembly), which may be important for structures that are large enough where this flexibility is not negligible.

The transmission system 110 is configured to operate (that is, deliver mechanical power or energy to) each of the propellers of the aircraft structure 102 (as depicted in FIG. 1 and FIG. 2) with, preferably, optimal generation of torque from the engine assembly 107. Torque received by the first propeller assembly 104 and/or the second propeller assembly 106 may be increased or decreased by the first power conversion assembly 214 and/or the second power conversion assembly 216.

A variation in the number of outputs, or of the ratio between an output of the contra-rotating mechanism 208 and inputs to the first variable-velocity assembly 224 and the second variable-velocity assembly 226 allows for the operation of more [pairs of] propeller assemblies, with an increase in velocity and a reduction of torque received by the propeller assemblies upon operation of the transmission system 110 (with power input from the engine assembly 107).

The contra-rotating mechanism 208 is configured for distribution of mechanical power in opposite rotational directions (for each of the first propeller assembly 104 and the second propeller assembly 106). More specifically, the contra-rotating mechanism 208 is configured to operate the first power conversion assembly 214 (as depicted in FIG. 6) and the second power conversion assembly 216 (as depicted in FIG. 6), so that the first power conversion assembly 214 and the second power conversion assembly 216 rotate in opposite directions.

A technical advantage for the transmission system 110 is that the engine assembly 107 may provide all the required mechanical power for utilization by the propellers of the aircraft structure 102 (as depicted in FIG. 1 and FIG. 2). This arrangement is in sharp contrast to a known aircraft configured to operate propellers (with two propellers per arm) by utilizing different electrical motors (one per propeller).

FIG. 7 depicts a schematic view of an embodiment of a transmission controller 223 of the transmission system 110 of FIG. 6.

Referring to the preferred embodiment as depicted in FIG. 7, the transmission system 110 includes a transmission controller 223. The transmission controller 223 is configured to receive flight data 225. The flight data 225 may include the flight path data of the aircraft structure 102, an input indicating a desired change in the flight path, etc. The transmission controller 223 is configured to control the velocity (the rotational velocity, in revolutions per minute) of the engine assembly 107, as well as the first variable-velocity assembly 224 and the second variable-velocity assembly 226, based on the flight data 225 that was received (by the transmission controller 223). Generally, the transmission controller 223 is configured to control the output velocity of the engine assembly 107 based on the flight data 225 (that was received) in such a way that the transmission controller 223, in use, urges the engine assembly 107 to provide (output) more or less torque as required (to the first propeller assembly 104 and the second propeller assembly 106) in combination by the first variable-velocity assembly 224 driving the first propeller assembly 104 and the second variable-velocity assembly 226 driving the second propeller assembly 106, as well as individual control of the conversion of this power by the first variable-velocity assembly 224 and the second variable-velocity assembly 226. This is done in such a way that the transmission controller 223, in use, urges the first variable-velocity assembly 224 and the second variable-velocity assembly 226 to move the first propeller assembly 104 and the second propeller assembly 106 (respectively) so that the first propeller assembly 104 and the second propeller assembly 106 (A) operatively rotate in opposite directions relative to each other, and (B) operatively rotate at different rotational speeds relative to a rotational speed of the engine assembly 107. This is done in such a way that the different rotational speeds of the first propeller assembly 104 and the second propeller assembly 106, in use, urge the aircraft structure 102 to fly along a flight path relative to the ground (based on the flight data 225 that was received by the transmission controller 223).

It will be appreciated that the transmission controller 223 is configured to cooperate with the first variable-velocity assembly 224 and/or the second variable-velocity assembly 226 (depicted in of FIG. 6), and to detect whether a maximum torque is demanded by the first propeller assembly 104 and/or the second propeller assembly 106, and to disable the transmission of power to the first propeller assembly 104 and/or the second propeller assembly 106 (since the first propeller assembly 104 and/or the second propeller assembly 106 may be inadvertently jammed or damaged). For the case where the first propeller assembly 104 is jammed and not able to rotate, the first variable-velocity assembly 224 is configured to disengage from the first propeller assembly 104 that has become jammed (prevented from rotation), and any remaining propellers may continue to be rotated (since they are not jammed).

Referring to the preferred embodiment as depicted in FIG. 7, the transmission controller 223 includes (and is not limited to) a memory assembly 702 configured to receive and tangibly store an executable program 704. The executable program 704 includes coded instructions (programmed coded instructions) configured to be readable by, and executable by, the transmission controller 223. The executable program 704 is configured to urge the transmission controller 223 to perform predetermined controller operations, such as a first operation 710 and a second operation 712 (depicted in the embodiment of FIG. 8). Equivalents to the executable program 704 include (and are not limited to): (A) machine-language code, (B) assembly-language code, and/or (C) source code formed in a high-level computing language understood by humans. The high-level language of the source code is compiled into either an executable machine code file or a non-executable machine-code object file. Other equivalents to the executable program 704 may include: (A) an application-specific integrated circuit, and any equivalent thereof, and/or (B) a field-programmable gate array (FPGA), and any equivalent thereof.

FIG. 8 depicts a schematic view of an embodiment of a flow chart 700 of an embodiment of the transmission controller 223 of the transmission system 110 of FIG. 7.

Referring to the preferred embodiment as depicted in FIG. 8, the first operation 710 includes instructing the transmission controller 223 to receive the flight data 225. The flight data 225 may include the flight path of the aircraft structure 102, an input indicating a desired change in the flight path, etc.

The second operation 712 includes instructing the transmission controller 223 to control (control the operation of) the first variable-velocity assembly 224 and the second variable-velocity assembly 226 based on the flight data 225 that was received. This is done in such a way that the transmission controller 223, in use, urges the first variable-velocity assembly 224 and the second variable-velocity assembly 226 to move the first propeller assembly 104 and the second propeller assembly 106 (respectively) so that the first propeller assembly 104 and the second propeller assembly 106 (A) operatively rotate in opposite directions relative to each other, and (B) operatively rotate at different rotational speeds relative to a rotational speed of the engine assembly 107. This is done in such a way that the different rotational speeds of the first propeller assembly 104 and the second propeller assembly 106, in use, urge the aircraft structure 102 to fly along a flight path relative to the ground (based on the flight data 225 that was received by the transmission controller 223).

FIG. 9 depicts a partial cross-sectional perspective view of an embodiment of the transmission system 110 of FIG. 6.

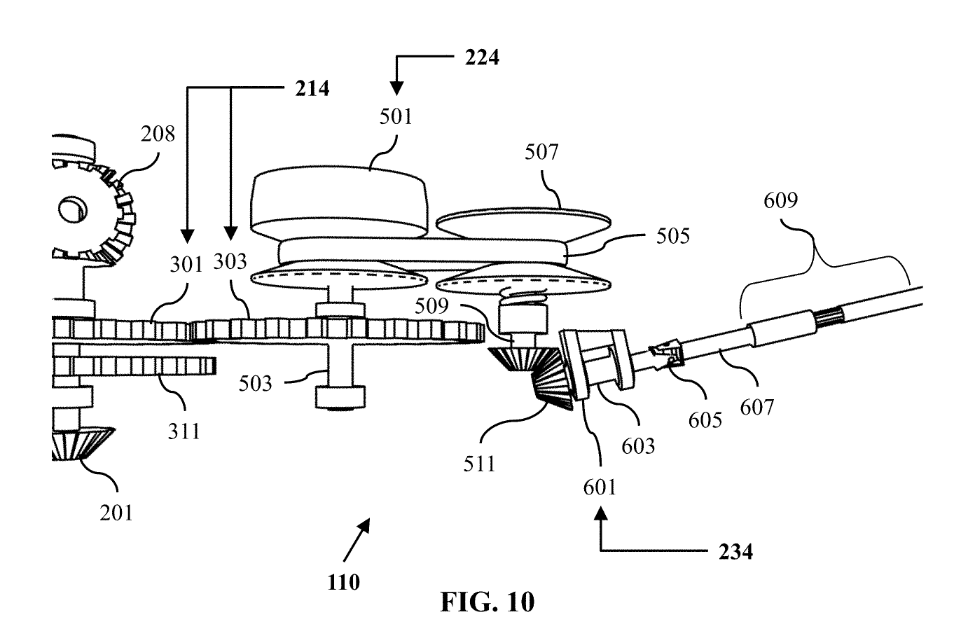

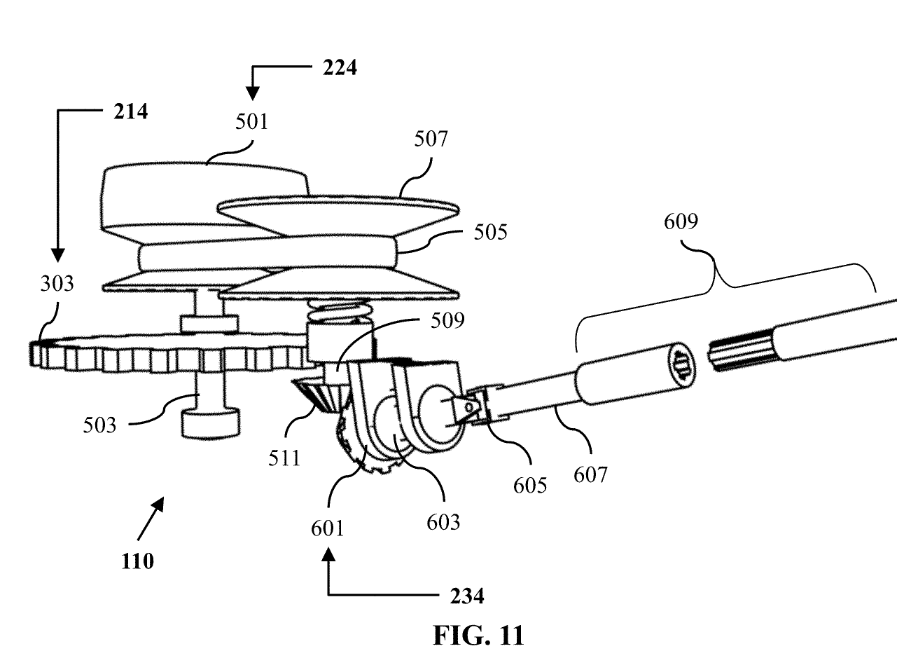

FIG. 10 and FIG. 11 depict close-up perspective views of embodiments of the transmission system 110 of FIG. 6.

Referring to the embodiment as depicted in FIG. 9, the contra-rotating mechanism 208 is configured to receive mechanical power from the engine assembly 107 (as depicted in FIG. 6) via the transmission input shaft assembly 202 of the transmission system 110. Mechanical power (to be provided by the engine assembly 107), in use, urges operation of the contra-rotating mechanism 208. In accordance with a preferred embodiment, the contra-rotating mechanism 208 includes counter rotatable gears or gear bevels.

The transmission input shaft assembly 202 includes a first transmission input shaft 204 (outer input shaft assembly, as depicted in the embodiment of FIG. 9), and a second transmission input shaft 206 (also called an inner input shaft assembly, as depicted in the embodiment of FIG. 9). The transmission shaft support assembly 209 is configured to support independent rotation of the transmission input shaft assembly 202 and the first transmission input shaft 204 (relative to each other). The first transmission input shaft 204 and the second transmission input shaft 206 are coaxially aligned with each other. The second transmission input shaft 206 is positioned (at least in part) within the first transmission input shaft 204. The second transmission input shaft 206 is receivable (at least in part) within the first transmission input shaft 204. The first transmission input shaft 204 and the second transmission input shaft 206 are rotatable relative to each other.

The input shaft coupler 201 is affixed to the second transmission input shaft 206. The second transmission input shaft 206 is affixed to an input of the contra-rotating mechanism 208. The first transmission input shaft 204 is affixed to an output of the contra-rotating mechanism 208. The first power conversion assembly 214 (such as the first input conversion gear 301) is affixed to the first transmission input shaft 204. The second power conversion assembly 216 (such as the second input conversion gear 311) is affixed to the second transmission input shaft 206.

The first transmission input shaft 204 and the second transmission input shaft 206 are configured to counter rotate relative to each other once the contra-rotating mechanism 208 is made to operate (by the rotation of the second transmission input shaft 206). The first input conversion gear 301 (that is, the first power conversion assembly 214) and the second input conversion gear 311 (that is, the second power conversion assembly 216) are configured to counter rotate relative to each other once the contra-rotating mechanism 208 is made to operate (by the rotation of the second transmission input shaft 206).

Referring to the embodiments as depicted in FIG. 10 and FIG. 11, the first transmission output assembly 234 is for the first propeller assembly 104. The first transmission output assembly 234 is similar to the second transmission output assembly 236 (for the second propeller assembly 106).

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a transmission system configured to be supported by an aircraft structure, in which the aircraft structure includes:
a first propeller assembly and a second propeller assembly which are configured to: (A) be supported by the aircraft structure at a first propeller position and a second propeller position, respectively, and (B) impart, in use, a thrust force to the aircraft structure in such a way that the aircraft structure is movable upwardly and away from the ground, and (C) be rotatable in opposite directions relative to each other, and (D) reduce, at least in part, a horizontal rotational effect applied to the aircraft structure by an individual rotation of each of the first propeller assembly and the second propeller assembly; and
an engine assembly that is configured to be supported by the aircraft structure; and
the transmission system further configured to:
be coupled to the engine assembly; and
be coupled to the first propeller assembly and the second propeller assembly in such a way that the transmission system, in use, urges the first propeller assembly and the second propeller assembly to be rotated once the engine assembly is activated; and
urge, in use, the first propeller assembly and the second propeller assembly to:
operatively rotate in opposite directions relative to each other; and
operatively rotate at different rotational speeds relative to a rotational speed of the engine assembly; and
whereby the different rotational speeds of the first propeller assembly and the second propeller assembly, in use, urge the aircraft structure to fly along a desired flight path relative to the ground.

2. The apparatus of claim 1, wherein:
the transmission system includes:
a first variable-velocity assembly configured to be coupled to the first propeller assembly; and
a second variable-velocity assembly configured to be coupled to the second propeller assembly.

3. The apparatus of claim 1, wherein:
the transmission system includes:
a first transmission output assembly configured to be coupled to the first propeller assembly; and
a second transmission output assembly configured to be coupled to the second propeller assembly; and
the first transmission output assembly and the second transmission output assembly are configured to be rotatable in opposite directions relative to each other.

4. The apparatus of claim 3, wherein:
the first transmission output assembly and the second transmission output assembly are configured be adjustable (lengthwise-adjustable and angle-adjustable) to allow for flexibility of the aircraft structure.

5. The apparatus of claim 1, wherein:
the first propeller assembly and the second propeller assembly, in use, contra-rotate relative to each other, and the elements of the transmission system, in use, counter-rotate relative to each other to negate rotational inertia effect on the aircraft structure.

6. The apparatus of claim 1, wherein:
the transmission system further includes:
a first power conversion assembly configured to be coupled to an output of the engine assembly in such a way that the engine assembly, in use, rotates the first power conversion assembly; and
a second power conversion assembly configured to be coupled to the output of the engine assembly in such a way that the engine assembly, in use, rotates the second power conversion assembly.

7. The apparatus of claim 6, wherein:
the transmission system further includes:
a first variable-velocity assembly configured to be coupled to the output of the first power conversion assembly in such a way that the first power conversion assembly, in use, rotates the first variable-velocity assembly; and
a second variable-velocity assembly configured to be coupled to the output of the second power conversion assembly in such a way that the second power conversion assembly, in use, rotates the second variable-velocity assembly.

8. The apparatus of claim 7, wherein:
the transmission system further includes:
a first transmission output assembly configured to:
couple to the output of the first variable-velocity assembly; and
couple to the first propeller assembly in such a way that the first variable-velocity assembly, in use, rotates the first transmission output assembly, and the first transmission output assembly, in use, rotates the first propeller assembly; and
a second transmission output assembly configured to:
couple to the output of the second variable-velocity assembly; and
couple to the second propeller assembly in such a way that the second variable-velocity assembly, in use, rotates the second transmission output assembly, and the second transmission output assembly, in use, rotates the second propeller assembly.

9. The apparatus of claim 8, wherein:
the transmission system is configured to counter rotate the first propeller assembly and the second propeller assembly. Advantageously, by having the first propeller assembly and the second propeller assembly rotatable at different relative rotational speeds, the first propeller assembly and the second propeller assembly, in use, urge movement of the aircraft structure along the desired flight path depending on a tilt imposed on the aircraft structure due to the relative rotational speeds between the first propeller assembly and the second propeller assembly.

10. The apparatus of claim 1, wherein:
the transmission system further includes:
a first power conversion assembly; and
a first variable-velocity assembly; and
a second power conversion assembly; and
a second variable-velocity assembly; and
wherein the first power conversion assembly is configured to feed mechanical power to the first variable-velocity assembly, which then feeds mechanical power to the first propeller assembly; and
wherein the second power conversion assembly is configured to feed mechanical power to the second variable-velocity assembly, which then feeds mechanical power to the second propeller assembly.

11. The apparatus of claim 1, wherein:
the transmission system further includes:
an input shaft coupler; and
a transmission input shaft assembly; and
a contra-rotating mechanism; and
a transmission shaft support assembly; and
a first power conversion assembly; and
a second power conversion assembly; and
a first variable-velocity assembly; and
a second variable-velocity assembly; and
a first transmission output assembly; and
a second transmission output assembly; and
wherein:
the input shaft coupler is configured to be coupled to an engine output coupler in such a way that the input shaft coupler is rotatable once the engine output coupler is made to rotate by activation of the engine assembly; and
the transmission input shaft assembly is affixed to the input shaft coupler in such a way that the transmission input shaft assembly is made to rotate once the input shaft coupler is made to rotate; and
the contra-rotating mechanism is coupled to a portion of the transmission input shaft assembly, and the contra-rotating mechanism is spaced apart from the input shaft coupler, and the contra-rotating mechanism is supported by the transmission input shaft assembly and in turn by the transmission shaft support assembly; and
the transmission shaft support assembly is configured to support a rotation of the transmission input shaft assembly; and
the first power conversion assembly is configured to be coupled to, and to rotate, the first transmission output assembly so that in turn the first transmission output assembly is coupled to the first propeller assembly; and
the second power conversion assembly is configured to be coupled to, and to rotate, the second transmission output assembly so that in turn the second power conversion assembly is coupled to the second propeller assembly.

12. The apparatus of claim 1, wherein:
the transmission system further includes:
a first variable-velocity assembly; and
a second variable-velocity assembly being spaced apart from the first variable-velocity assembly; and
wherein the first variable-velocity assembly and the second variable-velocity assembly each includes a continuously variable transmission.

13. The apparatus of claim 1, wherein:
the transmission system further includes:
a transmission input shaft assembly, including:
a first transmission input shaft; and
a second transmission input shaft; and
a contra-rotating mechanism coupled to the transmission input shaft assembly; and
a first power conversion assembly, including:
a first input conversion gear; and
a first output conversion gear; and
wherein the first input conversion gear is coupled to the first transmission input shaft of the transmission input shaft assembly, which is affixed to an input portion of the contra-rotating mechanism; and
the first output conversion gear is coupled to a first variable-velocity assembly.

14. The apparatus of claim 1, wherein:
the transmission system further includes:
a transmission input shaft assembly; and
a contra-rotating mechanism;
a second variable-velocity assembly being coupled to the second propeller assembly; and
a second power conversion assembly, including:
a second input conversion gear; and
a second output conversion gear; and
wherein the second input conversion gear is coupled to a second transmission input shaft of the transmission input shaft assembly, which is affixed to an output portion of the contra-rotating mechanism; and
the second output conversion gear is coupled to the second variable-velocity assembly.

15. The apparatus of claim 1, wherein:
the transmission system further includes:
a contra-rotating mechanism; and
a transmission input shaft assembly, including:
a first transmission input shaft; and
a second transmission input shaft; and
wherein the first transmission input shaft is affixed to an output portion of the contra-rotating mechanism; and
the second transmission input shaft is affixed to an input portion of the contra-rotating mechanism.

16. The apparatus of claim 1, wherein:
the transmission system further includes:
a first variable-velocity assembly for the first propeller assembly; and
a second variable-velocity assembly for the second propeller assembly; and
the first variable-velocity assembly is operated independently from the second variable-velocity assembly; and
the first variable-velocity assembly and the second variable-velocity assembly are each configured to convey a different amount of mechanical energy to the first propeller assembly and the second propeller assembly; and
the first variable-velocity assembly and the second variable-velocity assembly are configured for independent respective control of the rotational speeds of a first power conversion assembly, which is coupled to the first propeller assembly, and a second power conversion assembly, which is coupled to the second propeller assembly.

17. The apparatus of claim 1, wherein:
the transmission system further includes:
a first variable-velocity assembly, including:
a first driving pulley; and
a first input shaft; and
a first coupling device; and
a first driven pulley; and
a first output shaft; and
a first shaft coupler; and
wherein:
the first driving pulley is coupled to the first input shaft in such a way that the first driving pulley is made to be rotated once the first input shaft is rotated; and
an output of a first power conversion assembly is configured to rotate the first input shaft; and
the first coupling device is configured to rotate the first driven pulley in response to rotation of the first driving pulley; and
the first driven pulley is configured to rotate the first output shaft once the first coupling device, in use, rotates the first driven pulley; and
the first output shaft is connected to the first shaft coupler in such a way that the first output shaft and the first shaft coupler rotate in unison; and
the first shaft coupler is configured to be coupled to an input of a first transmission output assembly.

18. The apparatus of claim 1, wherein:
the transmission system further includes:
a first transmission output assembly including:
a first transmission-shaft support structure; and
a first extension shaft; and
a first variable angle shaft coupler; and
a first shaft portion; and
a first variable-length shaft assembly; and
wherein:
the first transmission-shaft support structure is configured to support rotation of the first extension shaft; and
the first extension shaft is configured to rotate; and
the first variable angle shaft coupler is configured to couple the first extension shaft to the first shaft portion; and
the first variable-length shaft assembly is attached to an end portion of the first shaft portion; and
the first variable-length shaft assembly is configured to be coupled to the first propeller assembly in such a way that the first propeller assembly is made to rotate once the first variable-length shaft assembly is made to rotate.

19. The apparatus of claim 1, wherein:
the transmission system further includes:
a first power conversion assembly; and
a second power conversion assembly; and
a contra-rotating mechanism configured for distribution of mechanical power in opposite rotational directions for each of the first propeller assembly and the second propeller assembly; and
the contra-rotating mechanism is configured to operate the first power conversion assembly and the second power conversion assembly so that the first power conversion assembly and the second power conversion assembly rotate in opposite directions.

20. The apparatus of claim 1, wherein:
the transmission system further includes:
a transmission controller configured to:
receive flight data, in which the flight data includes flight path data of the aircraft structure, and an input indicating a desired change in a flight path of the aircraft structure; and
control an output velocity of the engine assembly based on the flight data that was received in such a way that the transmission controller, in use, urges the engine assembly to provide more or less torque, as required, to the first propeller assembly and the second propeller assembly; and
control a first variable-velocity assembly and a second variable-velocity assembly based on the flight data that was received in such a way that the transmission controller, in use, urges the first variable-velocity assembly and the second variable-velocity assembly to move the first propeller assembly and the second propeller assembly, respectively, so that the first propeller assembly and the second propeller assembly operatively rotate in opposite directions relative to each other; and
operatively rotate at the different rotational speeds relative to the rotational speed of the engine assembly in such a way that the different rotational speeds of the first propeller assembly and the second propeller assembly, in use, urge the aircraft structure to fly along the flight path relative to the ground, based on the flight data that was received by the transmission controller.

21. The apparatus of claim 20, wherein:
the transmission controller includes:
a memory assembly configured to receive and tangibly store an executable program; and
the executable program includes coded instructions configured to be readable by, and executable by, the transmission controller; and
the executable program is configured to urge the transmission controller to perform a first operation and a second operation; and
the first operation includes instructing the transmission controller to receive the flight data; and
the second operation includes instructing the transmission controller to control operation of the first variable-velocity assembly and the second variable-velocity assembly based on the flight data that was received in such a way that the transmission controller, in use, urges the first variable-velocity assembly and the second variable-velocity assembly to move the first propeller assembly and the second propeller assembly, respectively, so that the first propeller assembly and the second propeller assembly:
(A) operatively rotate in opposite directions relative to each other; and
(B) operatively rotate at the different rotational speeds relative to the rotational speed of the engine assembly in such a way that the different rotational speeds of the first propeller assembly and the second propeller assembly, in use, urge the aircraft structure to fly along the flight path relative to the ground, based on the flight data that was received by the transmission controller.

22. The apparatus of claim 1, wherein:
the transmission system further includes:
a contra-rotating mechanism; and
a first power conversion assembly; and
a second power conversion assembly; and
a transmission input shaft assembly being coupled to the contra-rotating mechanism; and
the transmission input shaft assembly further includes:
a first transmission input shaft; and
a second transmission input shaft; and
a transmission shaft support assembly configured to support simultaneous rotation of the first transmission input shaft and the second transmission input shaft relative to each other; and
wherein:
the first transmission input shaft and the second transmission input shaft are rotatable relative to each other; and
the second transmission input shaft is affixed to an input of the contra-rotating mechanism; and
the first transmission input shaft is affixed to an output of the contra-rotating mechanism; and
the first power conversion assembly is affixed to the first transmission input shaft; and
the second power conversion assembly is affixed to the second transmission input shaft.

23. The apparatus of claim 20, wherein:
the transmission system further includes:
a contra-rotating mechanism; and
a first power conversion assembly configured to be coupled to an output of the engine assembly in such a way that the engine assembly, in use, rotates the first power conversion assembly; and
a second power conversion assembly configured to be coupled to the output of the engine assembly in such a way that the engine assembly, in use, rotates the second power conversion assembly; and
a transmission input shaft assembly having a first transmission input shaft and a second transmission input shaft; and
the first transmission input shaft and the second transmission input shaft are configured to counter rotate relative to each other once the contra-rotating mechanism is made to operate by a rotation of the second transmission input shaft; and
the first power conversion assembly and the second power conversion assembly are configured to counter rotate relative to each other once the contra-rotating mechanism is made to operate by the rotation of the second transmission input shaft.

24. An apparatus, comprising:
an aircraft structure; and
a first propeller assembly and a second propeller assembly which are configured to:
be supported by the aircraft structure at a first propeller position and a second propeller position, respectively; and
impart, in use, a thrust force to the aircraft structure in such a way that the aircraft structure is movable upwardly and away from the ground; and
be rotatable in opposite directions relative to each other; and
reduce, at least in part, a horizontal rotational effect applied to the aircraft structure by an individual rotation of each of the first propeller assembly and the second propeller assembly; and
an engine assembly that is configured to be supported by the aircraft structure; and
a transmission system that is configured to:
be supported by the aircraft structure; and
be coupled to the engine assembly; and
be coupled to the first propeller assembly and the second propeller assembly in such a way that the transmission system, in use, urges the first propeller assembly and the second propeller assembly to be rotated once the engine assembly is activated; and
urge, in use, the first propeller assembly and the second propeller assembly to:
operatively rotate in opposite directions relative to each other; and
operatively rotate at different rotational speeds relative to a rotational speed of the engine assembly; and
whereby the different rotational speeds of the first propeller assembly and the second propeller assembly, in use, urge the aircraft structure to fly along a flight path relative to the ground.
